(19) United States
(12) Patent Application Publication
(10) Pub. No.: US 2002/0002783 A1
(43) Pub. Date: Jan. 10, 2002

(54) Variable image-displaying member

(75) Inventors: Yoshinori Araki, Sagae-City (JP); Takiguchi Shigeyuki, Tendo-City (JP)

Correspondence Address: Rudolph P. Hofmann Jr., Office of Intellectual Property Counsel, 3M Innovative Properties Company, PO Box 33427, St. Paul, MN, 55133-3427, US

(73) Assignee: 3M Innovative Properties Copany

(21) Appl. No.: 09/870,183

(22) Filed: May 30, 2001

(30) Foreign Application Priority Data
Jun. 5, 2000 (JP) 2000-167001

(51) Int. Cl. G09F 3/04

(52) U.S. Cl. 40/447; 40/452

(57) ABSTRACT

A variable image-displaying member having an opaque substrate having a front surface which is observed by an observer, and a back surface opposing the front surface, and a plurality of pixel elements which are arranged on the front surface of the substrate in the row directions and the column directions which are perpendicular to the row directions. Each pixel element comprises a fixed part having the first fixed face which is fixed to the front surface of the substrate, the second fixed face adjacent to the first fixed surface, and a border line between the first fixed face and the second fixed face. An opaque shutter which is rotatable around an axis is in parallel with the border line between the fixed faces, between the first static state to shield the first fixed face of the fixed part and the second static state to shield the second fixed face of the fixed part, and which has the second observable face observed by the observer in the first static state, and the first observable face observed by the observer in the second static state, and in the first static state, the second fixed face of the fixed part and the second observable face of the shutter are juxtaposed each other to form the first visible pixel, in the second static state, the first fixed surface of the fixed part and the first observable face of the shutter are juxtaposed each other to form the second visible pixel, the static states of the pixel elements can be determined independently of each other or synchronously with each other, thereby an image composed of a plurality of the visible pixels is displayed.

### BACKGROUND

The present disclosure relates to a variable image-displaying member which displays variable images composed of visible pixels formed with a plurality of pixel elements.

A sign having a static image and a variable sign in which an image composed of a plurality of light-emitting pixels can be varied are known as a sign such as a road sign, a directional sign, etc. Further, one having improved visibility at night (a property to be seen brightly) is preferably used as such a sign. Thus, as a sign having a static image, one displaying an image formed with a retroreflective sheet is used. The image comprising the retroreflective sheet is illuminated with an external light source and can be brightly observed even at night.

A sign having a static image comprising a retroreflective sheet is disclosed in, for example, U.S. Pat. No. 5,050,327. The image of this sign is formed from a light-transmitting prismatic retroreflective sheet. The prismatic retroreflective sheet comprises a prismatic sheet having prism elements which are called cube corner prisms, and can reflect light in a specific direction by the effective use of a refraction function and a total reflection function of the prism elements. In addition, the prismatic sheet is made of a light-transmission polymer material, and thus the sheet as a whole allows light to transmit therethrough. Accordingly, the retroreflective sheet effectively reflect the illumination light entering the surface of the prismatic sheet, and allows the sign image to be brightly observed by an observer. On the other hand, the back light entering the back surface of the prismatic sheet can transmit through the sheet and thus the prismatic sheet allows the sign image to be brightly observed by an observer.

In addition to reflective sheets which increase only the visibility in a relatively narrow observation angle range, wide observation angle type reflective sheets which increase the visibility in a wide observation angle range are used. As a sign-illuminating system which uses a sign having an image comprising a wide observation angle type reflective sheet, Japanese Patent No. 2,910,868 (corresponding to U.S. Pat. No. 5,818,640) discloses an external illumination type sign-illuminating system comprising a sign and an external light source. In this system, the light source is arranged so that it emits light which enters the sign surface at an incident angle in the range between 0 degree and 30 degrees. In general, a retroreflective sheet having a sign image thereon is adhered to the sign surface. The reflective sheet, which is improved to have a wide observation angle range, comprises optical refractive elements such as glass beads, prism elements, etc., and reflection elements such as deposited metal films, etc. In the case of the above described cube corner prism elements, the light can be reflected in a specific direction using the total reflection function of the prisms without reflection elements.

Furthermore, signs are known, which comprise a variable image-displaying member and can display variable images composed of a plurality of light-emitting pixels. Such image-displaying members commonly have the following components:

(A) a substrate having a front surface which is observed by an observer, and a back surface opposing said front surface, and

(B) a plurality of pixel elements which are arranged on the front surface of the substrate in the row directions and the column directions which are perpendicular to the row directions.

Each pixel element has an internal light source as an essential component, and the light source emits light. The pixel elements form visible pixels in a state observable by an observer, and an image can be composed of a composite of a plurality of the visible pixels. Well known examples of such variable image-displaying members include electronic signs, and the like. An electronic sign-type image-displaying member is disclosed in, for example, WO97/3 9436. The variable image-displaying member uses pixel elements comprising light-emitting panels which have one or more light-emitting elements such as LED as internal light sources.

In the case of such a variable image-displaying member, a plurality of visible pixels, which compose an observable image, are light-emitting pixels consisting of light-emitting panels which emit light. Background parts, which function to make the contour of the image clear, are composed of non-light-emitting pixels which does not emit light. That is, the image can be varied by controlling the light emission from the pixels with the aid of a computer so that the pixels at certain positions on the front surface of the substrate are allowed to emit light while other pixels are not.

However, the above-described variable image-displaying members may not display images, if a part or all of the light-emitting elements cannot emit light because of the troubles of the light-emitting elements or electronic control circuits. Therefore, it is proposed to include the above-described reflective members comprising the prismatic sheets (prismatic sheet reflectors) in parts corresponding to the light-emitting panels. That is, a variable image-displaying member is improved so that an image can be observed by reflecting light from an external light source at a high luminance with the reflectors on the surfaces of the light-emitting parts, even if the light-emitting elements do not emit light due to certain troubles.

In the case of such a type of a variable image-displaying member, a light-transmitting reflector comprising a prismatic sheet is provided on the surface of the light-emitting parts, and thus the light from the light-emitting elements illuminates the light-emitting part from its backside. As described above, the light illuminated from the backside of the prismatic sheet passes through the prismatic sheet, and allows the image to be brightly observed by the observer. Accordingly, this type of the variable image-displaying member can function in the same way as the above-described electronic sign-type variable image-displaying member, when the internal light sources (e.g. light-emitting elements) can emit light.

Such a variable image-displaying member has a structure shown in FIG. 6. In the variable image-displaying member (9), each pixel element comprises

(i) a fixed part having light-emitting part (93) formed on the front face of the substrate (90), the adjacent area (94) which is adjacent to the light-emitting part, and the border line (96) formed between the light-emitting part and the adjacent area, and

(ii) the opaque shutter (91) which is rotatably fixed to a respective axis in parallel with the border line (96), which is movable between the first static state to shield the light-emitting part (93), and the second static state to open the light-emitting part (93), and which has the second face (912) facing an observer in the first static state and the first face (911) facing the observer in the second static state.

In the second static state, the light-emitting part (93) and the first face (911) of the shutter are observed with being arranged in parallel with each other on the front face of the substrate, and form a visible pixel. In this state, the light-emitting part emits light. In general, prismatic sheet reflectors having the same color are arranged on the light-emitting part (93) and the first face (911) of the shutter.

In the first static state, the light emitting-part (93) is shielded. Thus, the light-emitting part (93) and the first face (911) of the shutter cannot be observed, even when they are externally illuminated. The second face (912) of the shutter and the adjacent area (94), which face the observer in the first static state, are generally colored black. Thus, they can effectively form the non-light-emitting pixel as a background, which functions to make the contour of the image formed with the visible pixels clear. Accordingly, the image can be varied by controlling the states of the pixels so that some pixel elements (shutters) are in the first state and the corresponding light-emitting parts (93) are allowed to emit light, while the rest of the pixel elements are in the second state. The static states of the pixel elements are determined independently of each other.

In general, the light-emitting part (93) consists of (1) an opening formed of a through hole provided in the substrate and a prismatic sheet reflector provided to cover the whole opening, or (2) a light-emitting-reflection module which is detachably provided in an opening formed of a through hole provided in the substrate.

A variable image-displaying member having the light-emitting parts of the structure (1) is disclosed in, for example, U.S. Pat. No. 5,050,327, while one having the light-emitting parts of the structure (2) is disclosed in, for example, U.S. Pat. Nos. 5,148,156, 5,500,652 and 5,790,088.

The light-emitting-reflection module of the structure (2) comprises a small-sized light-emitting device such as LED, and a prismatic sheet reflector. Thus, in the case of the trouble of the light-emitting device or the expiration of the life, the module of each light-emitting part should be replaced. To facilitate the exchange of the module, the light-emitting-reflection modules are detachably mounted in the respective openings which are formed at the designed positions.

In the case of the structure (1), at least one internal light source (e.g. a fluorescent lamp, etc.) is provided on the backside of the substrate to illuminate the back surfaces of the prismatic sheet reflectors through the openings.

In either structure, a plurality of openings are required to form a plurality of light-emitting parts.

The conventional variable image-displaying members having the shutters are advantageous for the production of signs displaying simple words or sentences, but are not suitable for the production of image-displaying members or devices to display variable signs, which can change one static image to other static image. Such variable-displaying members or devices are being used in place of conventional road signs or directional signs carrying printed static images. The reason for the above will be explained by making reference to FIG. 6.

As described above, in general, a plurality of visible pixels used to compose an observable image comprise light-emitting parts (93). The background parts, which make the contours of the images clear, are composed of the adjacent areas (94), and the second faces (912) of the shutters (91).

In the case of the conventional signs carrying the printed static images, the backgrounds should be observed in a relatively bright color (e.g. red, yellow, blue, green, etc.). However, in the conventional variable image-displaying members, the adjacent areas (94) and the second faces (912) of the shutters (91) are colored black. If they are colored bright color, the difference of brightness between the non-light-emitting pixels and the light-emitting pixels is too large, so that the observers may have different visual feeling in comparison with the conventional printed static signs. Therefore, it may be difficult to maintain the compatibility with the conventional static image signs.

It is advantageous for images composed of a plurality of visible pixels to be substantially continuously seen, to display relatively complicated designs or marks or characters having a relatively large number of strokes such as Chinese characters and to maintain the compatibility with the conventional printed static image signs. To this end, the size (width) of the frame (95) between the adjacent openings should be made as small as possible so that the image can be seen continuously. However, the reduction of the width of the frame (95) will decrease the mechanical strength of the frame (95) itself, and in turn, the mechanical strength of the substrate (90) having a plurality of such frames with a narrow width. To increase the mechanical strength of such a substrate, the thickness of the substrate may be increased, or a material having a larger density is used to produce a substrate. However, the increase of the thickness of the substrate, or the use of the material having a larger density makes it difficult to decrease the thickness of the display or reduce the weight of the display.

For example, some road signs have image-displaying planes with a relatively large area (e.g. 1 m² or larger). To maintain the compatibility with such a large static image sign, a variable image-displaying member having an image-displaying plane with a relatively large area should be produced. In addition, the weight and thickness (a size in the direction perpendicular to the sign plane) of the conventional variable image-displaying member include the weight of the light-emitting units including light sources, and the size of a space in which the light-emitting units are mounted. However, the increase of the weight or thickness of the substrate will make it difficult to reduce the weight and thickness of the displaying member as a whole so that the compatibility with the static image sign is maintained.

### SUMMARY

The present disclosure is directed to a variable image-displaying member, which can form a variable image sign having the compatibility with a conventional sign carrying a printed static image, which does not generate different visual feeling from the sign carrying the conventional printed static image, which does not make it difficult to reduce the weight or thickness of the displaying member as a whole, and which allows the image composed of a plurality of visible pixels to be seen continuously.

With the variable image-displaying member of the present disclosure, the composed images can be illuminated with an external light source and observed. Thus, it is not necessary for the variable image-displaying member to have a light source which allows the pixels to emit light, The observable pixels can be observed brightly (at a high luminance) with the external light source, since they have the reflective surfaces. Accordingly, the variable image-displaying member of the present invention can be suitably used as a sign such as a road sign and a directional sign, or a component of such a sign.

The present invention relates to the improvement of a variable image-displaying member in which each pixel element comprises (a) two fixed faces on the front surface of the substrate, and (b) an opaque shutter, which is rotatable between two static states, wherein, in one of the two static state, the shutter shields one of the fixed faces so that it becomes unobservable, and the shutter allows the other fixed face to open so that it becomes observable, and one of the surface and the back surface of the shutter is observable in either static state. In such an image-displaying member, the pixel elements are changed between two static states, and form visible pixels in each static state. Thus, the image composed of such visible pixels can be changed to display a plurality of images.

In one aspect, the present disclosure provides a variable image-displaying member comprising an opaque substrate having a front surface which is observed by an observer, and a back surface opposing said front surface, and a plurality of pixel elements which are arranged on said front surface of the substrate in the row directions and the column directions which are perpendicular to the row directions. Each pixel element comprises a fixed part having the first fixed face which is fixed to said front surface of the substrate, the second fixed face adjacent to said first fixed surface, and a border line between said first fixed-face and said second fixed face, and an opaque shutter which is rotatable around an axis, that is in parallel with said border line between said fixed faces, between the first static state to shield said first fixed face of said fixed part and the second static state to shield said second fixed face of said fixed part, and which has the second observable face observed by the observer in said first static state, and the first observable face observed by the observer in said second static state. In said first static state, said second fixed face of the fixed part and said second observable face of the shutter are juxtaposed each other to form the first visible pixel. In said second static state, said first fixed surface of the fixed part and said first observable face of the shutter are juxtaposed each other to form the second visible pixel. The static states of said pixel elements can be determined independently of each other or synchronously with each other. Thereby an image composed of a plurality of the visible pixels is displayed, characterized in that said first and second fixed faces consist of a respective reflective surface of a substantially opaque reflective member which covers said front surface of the substrate, said first and second observable faces consist of a respective reflective surface of a substantially opaque reflective member which covers the surface and back surface of said shutter, and said composed image is illuminated with an external light source and observed.

In the variable image-displaying member of the present invention, the two fixed faces (the first and second fixed faces) on the front surface of the substrate, and the surface and back surface (the first and second observable faces) of the shutter consist of respective reflective surfaces of substantially opaque reflective members. That is, the image composed of such visible pixels is illuminated with an external light source, and can be observed at a high luminance. Accordingly, it is not necessary to form openings (through holes) in the substrate and utilize the transmitted light from the backside of the substrate in order to increase the visibility of the visible pixels. Thus, the above problem is solved, and the sign carrying the variable sign, which is compatible with the conventional sign carrying the printed static image, can be obtained.

The reflective member used in the present disclosure is usually a reflective sheet such as a retroreflective sheet. Thus, the reflective surface can be easily formed by the adhesion of the reflective sheet to the component such as the substrate.

### BRIEF DESCRIPTION OF THE DRAWINGS

FIG. 1 A plan view of one example of the variable image-displaying member of the present invention.

FIG. 2 Cross sections of one example of the variable image-displaying member of the present invention in two static states.

FIG. 3 Plan views showing two states of the variable ordering sign of Example 1.

FIG. 4 Plan views showing two states of the variable ordering sign of Example 2 including the variable image-displaying member as a part.

FIG. 5 Plan views showing two states of the variable ordering sign of Example 3 including the variable image-displaying member as a part.

FIG. 6 A plan view of one example of the variable image-displaying member of the prior art.

### DETAILED DESCRIPTION

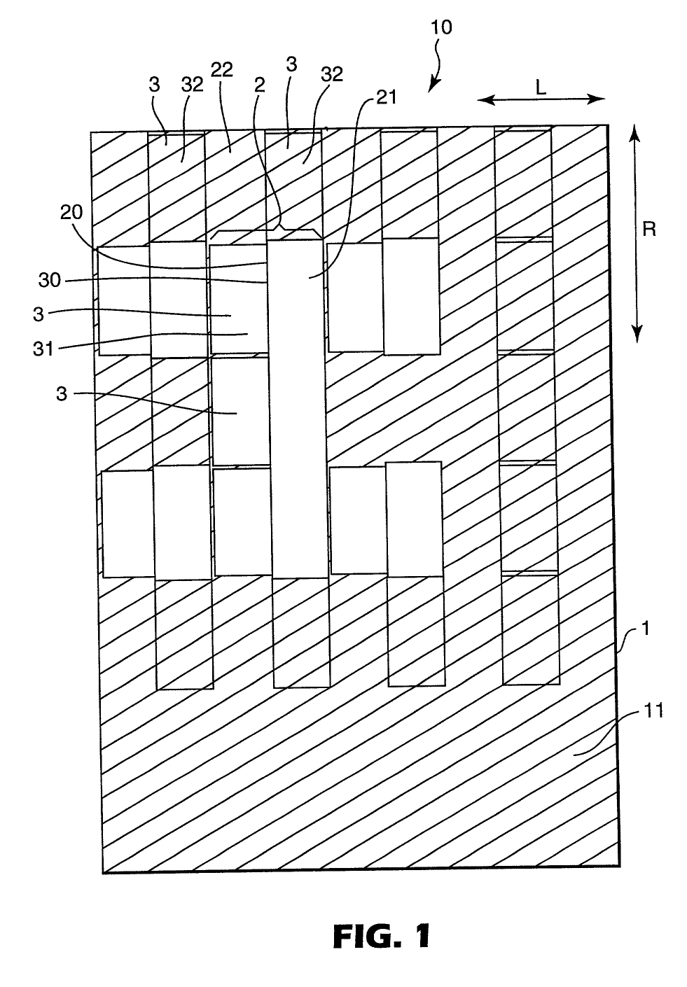

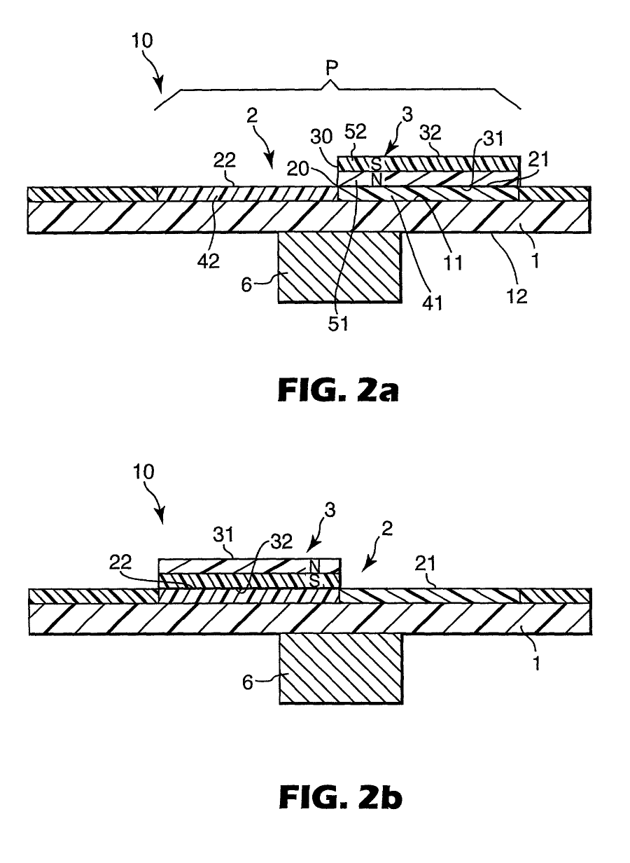

One preferable example of the variable image-displaying member of the present invention will be explained by making reference to FIGS. 1 and 2.

The shown variable image-displaying member (10) comprises

(A) the opaque substrate (1) having the front surface (11) which is observed by an observer, and the back surface (12) opposing the front surface (11), and

(B) a plurality of pixel elements (P) which are arranged on the front surface (11) of the substrate in the row directions (L) and the column directions (R).

The substrate (1) has no through hole (opening) at a part at which the pixel element (P) is provided.

Each pixel element (P) comprises the fixed part (2), which is fixed to said front surface of the substrate, and has the first fixed face (21), the second fixed face (22) adjacent to the first fixed face in the row direction (L) of the front surface of the substrate. The fixed part (2) comprises two different reflective members which are arranged adjacently to each other and cover the front surface (11) of the substrate, and the reflective surfaces of the reflective members constitute the first fixed face (21) and the second fixed face (22), respectively. In addition, the border line (20) is formed between the first fixed face (21) and the second fixed face (22).

In the example of FIGS. 1 and 2, each fixed part (2) consists of the first reflective sheet (41) having a white reflective surface and the second reflective sheet (42) having a colored reflective surface, which are fixed to the front surface (11) of the substrate with an adhesive (not shown). That is, the first fixed face (21) consists of the reflective surface of the first reflective sheet (41), while the second fixed face (22) consists of the reflective surface of the second reflective sheet (42).

A usual reflective sheet has a white reflective surface. Thus, a reflective sheet having a colored reflective surface may be produced by providing a transparent color ink layer or a transparent colored film on the reflective surface of the white reflective sheet.

In addition to the fixed parts (2), each pixel element has the opaque shutter (3). The shutter (3) has two main surfaces (a surface and a back surface) having geometrical shape. The shape of the main surface of the shutter may be a triangle, a rectangle, a semicircle, a semi-ellipse, etc. In the shown example, the main surface of the shutter has an oblong plane form.

The shutter (3) is rotatably fixed around an axis (not shown) in parallel with the column direction (R) of the front surface of the substrate, that is, in parallel with the border line (20). For example, a rotation axis is fixed to the front surface (11) of the substrate in parallel with the border line (20), and the shutter (3) is rotatably fixed to the axis. In this case, the shutter (3) has a bearing having a bore to receive the rotation axis at or near one edge part (30) corresponding to the longer side of the rectangle of the main surface.

The rotation axis may be fixed to the shutter (3). In this case, a bearing member is fixed to the front surface (11) of the substrate along the border line (20), and the rotation axis of the shutter is received in the bearing member to rotatably fix the shutter (3) to the front surface of the substrate. The rotation axis in this case comprises a pair of axes fixed to the side surfaces of the rectangle of the main surface of the shutter corresponding to the two shorter sides, so that the axes extend in the direction perpendicular to the rotation direction of the shutter near the edge part (30).

The bearing member in the example is colored with the same color as that of one of the fixed faces, or made of a colorless transparent plastic. In the latter case, the bearing member may be molded integrally with the colorless transparent plastic sheet or plate which covers the whole fixed surface of the substrate and may be used as a covering sheet or plate to protect the fixed surface.

The shutter (3) performs as follows through the interaction of the electromagnet (6) attached to the back surface (12) and a permanent magnet built in the shutter (only the polarities being shown in FIG. 2), although the details of the performance of the shutter will be described later:

The shutter (3) rotates in the row direction (L) between the first static state (FIG. 2(a)) in which the shutter shields the first fixed face (21) of the fixed part (2) so that the first fixed face (21) is not observed, and the second static state (FIG. 2(b)) in which the shutter shields the second fixed face (22) so that the second fixed face (22) is not observed.

The rotation axis may be arranged in parallel with the row direction (L). In this case, the border line between the two fixed faces is in parallel with the row direction (L), and the shutter rotates in the column direction (R).

Furthermore, the rotation axis may incline from the row direction or the column direction. In this case, the border line between the two fixed faces inclines like the rotation axis, and the plane shape of the shutter is preferably a triangle. That is, the shutter is preferably rotated around an axis which is in parallel with the diagonal line of the square pixel.

The shutter (3) has the second observable face (32) observed by the observer in the first static state, and the first observable face (31) observed by the observer in the second static state. In the shown example, one main surface of the shutter is the first observable face (31), and the other main surface is the second observable face (32). For example, the shutter (3) comprises the first reflective sheet (51) having a white reflective surface, and the second reflective sheet (52) having a colored reflective surface, which is adhered to the non-reflective surface of the first reflective sheet (51). That is, the first observable face (31) is the reflective surface of the first reflective sheet (51), and the second observable face (32) is the reflective surface of the second reflective sheet (52). The second reflective surface of the second reflective sheet (52) of the shutter (3) is colored with the same color as that of the second fixed face. Alternatively, the shutter (3) may comprise a sheet-form support, the first reflective sheet (51) adhered to one main surface of the support, and the second reflective sheet (52) adhered to the other main surface of the support.

In the first static state, the second fixed face (22) of the fixed part (2) and the second observable face (32) of the shutter (3), are observed while they are juxtaposed each other on the front surface (11) of the substrate, and form the first colored visible pixel. On the other hand, in the second static state, the first fixed face (21) of the fixed part (2) and the first observable face (31) of the shutter (3) are observed while they are juxtaposed each other on the front surface (11) of the substrate, and form the second white visible pixel.

The static states of the pixel elements (P) can be determined independently of each other or synchronously with each other, like the conventional variable image-displaying members. Thereby, the displaying member can display the images composed of a plurality of visible pixels. To control the static states of the pixel elements (P), the methods disclosed in U.S. Pat. Nos. 5,148,156 and 5,500,652, 5,790,088, etc. may be used.

Unlike the conventional displaying members, in the variable image-displaying member of the present invention, the first and second fixed faces (21) and (22) consist of the reflective surfaces of the opaque reflective sheets (41) and (42), respectively, and also the first and second observable faces (31) and (32) of the shutter (3) consist of the reflective surfaces of the opaque reflective sheets (51) and (52), respectively. Thus, the image composed of a plurality of the visible pixels can be observed at a high luminance, when it is illuminated with the external light source.

The reflective sheets (41, 42, 51, 52) may be retroreflective sheets (including wide observation angle reflective sheets). The reflective sheets preferably has the observation angle characteristic (A), which is defined as follows:

Observation angle characteristic (A):

A reflection luminance measured according to JIS Z 9117 being in the range between 0.2 and 100 cd.lux⁻¹.m⁻² at an incident angle of 0 degree and an observation angle of 10 to 20 degrees.

When the reflection luminance is less than 0.2 cd.lux⁻¹.m⁻², the visibility of the image may deteriorate at night. When the reflection luminance exceeds 100 cd.lux⁻¹.m⁻², the legibility of the information in the image such as characters may deteriorate, and the appearance of the image may differ between at night and in the daytime. Furthermore, the reflection luminance at an incident angle of 0 degree and an observation angle of less than 10 degrees, for example, 4 degrees is usually at least 0.2 cd.lux⁻¹.m⁻², preferably at least 1 cd.lux⁻¹.m⁻², more preferably 10 to 500 cd.lux⁻¹.m⁻². The displaying member is preferably illuminated with a light source at the illuminance on the image surface (plane surface illuminance) of 10 to 400 lux.

Specific examples of the retroreflective sheets include those sold under the trademark DIAMOND GRADE Nos. 3963, 3990, 3983, 3924, 3951, 3970, 3971 and 981 (all available from 3M), Reflective sheets sold under the trademarks HV 8100, HIGH INTENSITY GRADE 3870 and ENGINEER GRADE 3290 (both available from Sumitomo 3M), and “CRYSTAL GRADE SERIES” (available from Nippon Carbide Industries Co., Ltd.), etc.

In the example of FIG. 1, the first fixed face (21) and the second fixed face (22) are continuous in the column direction (R) in parallel with the front surface (11) of the substrate. Thus, it becomes very easy for the image composed of the visible pixels to be continuously seen. When the fixed faces are continuous in the direction in parallel with the rotation axis (the border line between the two fixed fates), one visible pixel in one static state consists of (1) one observable face of the shutter, and (2) a part of the fixed face adjacent to this observable face. For example, when the size of the shutter in the row direction is 30 mm, in a state where the shutter stands still with one observable face being opened, one visible pixel is composed of (1) this opened observable face of the shutter, for example, the first observable face, and (2) a part of the fixed face (for example, the first fixed face) of the fixed surface adjacent to this observable face, which part has the size of 30 mm in the row direction.

The visible pixel is usually formed of a reflective face which is substantially a square. The length of one side of the square is usually 50 mm or less. To smoothen the contour of the image composed of a plurality of the visible pixels, for example, an image including characters having a relatively large number of strokes such as Chinese characters, the length of one side of the visible pixel is preferably 20 mm or less. When the length of one side is too small, the movement of the shutters and its control may become difficult. Thus, the length of one side of the visible pixel is preferably at least 5 mm.

The distance between the adjacent shutters is preferably small, since the composed image is easily seen continuously. If the size accuracy of the shutters themselves, or the positioning accuracy of the shutters fixed to the substrate has an error, the movement of the shutters may be obstructed. Accordingly, the distance between the adjacent shutters is usually from 0.5 to 5 mm, preferably from 0.8 to 3 mm.

As described above, to move the shutter, the interaction of the electromagnet placed on the back surface of the substrate and the permanent magnet built in the shutter can be utilized.

The electromagnet placed on the back surface of the substrate comprises a coil consisted of a conductor wound in a plurality of turns. In addition, a core such as an iron core may be placed in the coil.

The movement of the shutter to change one static state to the other will be explained in detail by making reference to FIG. 2.

In the first static state (FIG. 2(a)), the shutter (3) rests on the substrate (1) with the N pole of the magnet facing the front surface of the substrate, while the second observable face (32) facing outside. When an electric current is supplied to the electromagnet so that the pole of the electromagnet (6) close to the back surface of the substrate becomes the N pole, the N pole of the shutter and the electromagnet repel each other, and thus the shutter (3) rotates. After the rotation, the S pole of the shutter (3) is attracted by the N pole of the electromagnet (6) close to the back surface of the substrate, and thus the shutter (3) rests in the second static state (FIG. 2(b)) with the first observable face (31) facing outside. In this state, the electric current supplied to the electromagnet (6) may be shut down. In this state, the magnetic line of force from the magnet in the shutter passes in the coil (not shown) of the electromagnet (6). Thus, the coil and the magnet in the shutter can attract each other with a sufficient force for maintaining the static state, although the attracting force is weak. When the reverse procedure of the above is performed, the position of the shutter can be changed from the second static state to the first static state.

When such the movement of the shutter is carried out in the pixel elements independently of each other or synchronously with each other, the visible pixels are changed and, in turn, the image is changed.

The permanent magnet of the shutter is not limited, insofar as the shutter can move as described above. For example, a permanent magnet made of a magnetic material such as ferrites (e.g. barium ferrite, etc.), alnico, rare earth element-cobalt (e.g. samarium-cobalt, etc.), rare earth element-ion-boron (e.g. neodymium-iron-boron, etc.), and the like. These magnetic materials have relatively high magnetic properties (e.g. a residual magnetic flux density, a coercive force, a maximum energy product, etc.), and can form a permanent magnet having as small plane sizes and thickness as possible. Thus, the shutter for the pixel element can be produced without unnecessarily increasing the thickness and weight of the shutter.

The permanent magnet for the shutter can be mounted in the shutter as follows:

For example, when the shutter is produced by adhering reflective sheets to the respective main surfaces of the support, the magnet can be embedded in the support, or the support may be made of a plastic magnet.

Alternatively, the shutter is formed of a shutter member having reflective sheets on both surfaces, and a shutter support to fix the shutter member, and the magnet is built in the shutter support. In general, such a shutter support has (1) a support part for the shutter member, which has a substantially rectangular surface, and (2) a permanent magnet mounted in the support part.

To mount the magnet in the support part of the shutter member, (i) the support part is made of a permanent magnet such as a plastic magnet, or (ii) a permanent magnet is fixed to the surface of the support part.

The shutter member may be produced by adhering two reflective sheets with their non-reflective surfaces facing each other to form a reflective sheet laminate, and cutting the laminate in a desired shape and plane sizes.

The shutter member and the support part for the shutter member are fixed with the back surface of the support part facing the one of the reflective surface of the shutter member. Thus, the surface of the support part for the support member is colored with the same color as that of one of the reflective surface of the shutter member (the surface of the reflective sheet). Alternatively, the support part for the shutter member may be formed of a reflective sheet like the shutter member. Furthermore, the support part for the shutter member may be formed of a colorless transparent plastic. In the case of the colorless transparent support part, the support part may cover the whole reflective surface of the shutter member.

Since the variable image-displaying member of the present invention does not have any internal light source, only a relatively small electric current necessary to move the shutters is supplied to the displaying member. Thus, the consumed electricity can be made as small as possible, and it is possible to function the displaying member with the combination of a solar cell and a storage battery. A solar cell or a condensing unit connected to the solar cell is placed on the surface of the sign, and electric power necessary to move the shutters is optically generated using the light of the external light source which illuminates the sign surface.

### EXAMPLES

### Example 1

In this Example, a variable traffic sign displaying “NO ENTRY EXCEPT INDICATED DIRECTION(S)” was produced. The variable traffic sign (variable image-displaying member) of this Example was produced as follows:

As a substrate, an aluminum disc having a diameter of 900 mm and a thickness of 1.5 mm was provided. This substrate was used as a substrate of a conventional sign having a printed static image.

Separately, a reflector was provided to form the fixed part. This reflector was a reflection sheet sold under the trademark DIAMOND GRADE No. 3990 (White) available from 3M.

As shown in FIG. 1, the first fixed faces (21) and the second fixed faces (22) were formed on the white reflective surface of the reflective sheet by silk screen printing. The printing was carried out with a transparent blue ink using a silk screen printing plate which was produced so that the parts corresponding to the first fixed faces (21) and the circular peripheral part around the substrate disc were made impermeable to the ink. Thereby, (1) parts consisting of the above reflective sheet and the blueprinted layers formed on the reflective sheet and having the second fixed faces (22) formed of the surface of the blueprinted layers, and (2) the fixed parts (2) consisting of the unprinted parts of the reflected sheet and having the white reflective surfaces as the first fixed faces (21) were formed.

The blueprinted layers of the fixed parts consisted of stripes each having a width (a size in the row direction) of 17 mm, which continuously extended in the column direction, while the unprinted parts consisted of stripes having a width (a size in the row direction) of 15 mm, which continuously extended in the column direction. The blue and white stripes (each 28 stripes) were formed so that the blue stripes and the white strips were alternately arranged. Then, the reflective sheet having the fixed faces was adhered to one of the main surface of the aluminum disc with an adhesive.

Separately, the shutter (3) were produced.

Firstly, a shutter member was produced as follows:

The above reflective sheet sold under the trademark DIAMOND GRADE No. 3990 (White) was provided. The reflective surface of another reflective sheet No. 3990 was solidly printed with the above transparent blue ink. Then, the two reflective sheets were adhered with their non-reflective surfaces facing each other to form a laminate. This laminate was cut in the form of a rectangle of 15 mm×30 mm to obtain a shutter member consisting of the laminate of the two reflective sheets.

Next, the above shutter member was fixed to a shutter support to obtain the shutter (3) used in this Example. The shutter support had (i) a support part for a shutter member, which was made of a colorless transparent plastic sheet having a plane size of 15 mm×30 mm, (ii) a permanent magnet (in a disc form having a diameter of about 6 mm and a thickness of about 4 mm) which was fixed at a position at the center of the lengthwise direction and near the one edge in the widthwise direction, and (iii) a pair of rotation axes which were integrally fixed to the respective comers opposing each other along one long side of the rectangle support part and each of which had a length of about 4 mm. The shutter member was adhered to the support part using a transparent adhesive with the back surface of the support part and the blue reflective surface of the shutter member facing each other.

Separately, a plurality of bearing members made of the colorless transparent plastic of the reflective sheet were fixed along the border lines (20) between the two types of the fixed faces. Each bearing member was fixed to the designed position on the border line so that it would receive one rotation axis of the shutter member, a pair of the bearing members rotationally supported one shutter, and the shutter could rotate smoothly.

Subsequently, the shutters (3) were rotatably provided on the respective bearing members to form, on the aluminum substrate, a plurality of pixel elements each of which comprised (a) one shutter (3), and (b) the first and second fixed parts (21, 22) each of which had a size of 30 mm in the lengthwise direction, and which are adjacent to each other through the border line (20) to which the shutter was rotatably fixed. The visible pixel composed of each pixel element was in the form of a substantial square having a side length of about 30 mm, and 584 pixel elements were formed on the substrate.

Finally, a plurality of electromagnets (6) were attached on the back surface (12) of the substrate near the border lines (20) so that one electromagnet corresponded to one pixel element. Thus, the sign consisting of the variable image-displaying member of this Example was finished.

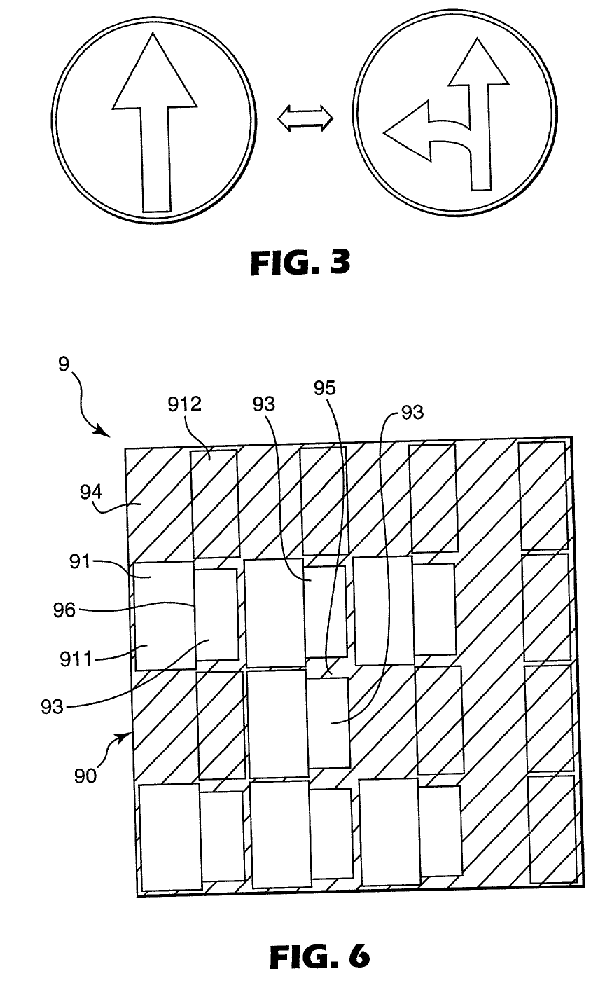

This sign was positioned with the column direction (L) being in parallel with the vertical direction, and operated. The images of FIG. 3 were prepared as bit map data, and the ON/OFF and polarities of the electromagnets were controlled by a computer to control the static state of each pixel element. Thus, each image was displayed. The sign image on the left side of FIG. 3 and that on the right side of FIG. 3 were reversibly changed by the control of the operation of the electromagnets.

With each image displayed by the sign of this Example, indents of the formed image were more or less harsh, when the sign was observed from a short distance, but the number, shapes and directions of arrows in the variable image were recognized in the daytime and at night like the conventional printed static image sign when it was observed from a distance of 10 m or more. At night, the sign was illuminated with a metal halide lamp “M400 L/BH-SC” of Matshushita Electric Industrial Co., Ltd.

With the sign of this Example, the static states of the pixel elements can be controlled independently of each other. Thus, it can display other desired images freely in addition to the above two images, and therefore it is the free-pattern (multi-pattern) type variable sign.

### Example 2

This Example produced a variable directional sign displaying “partly variable directional sign of directions and courses”. This destination sign can variably display several types of destination information, which are different from season to season. The variable sign of this Example was produced in the same manner as that in Example 1 except some points.

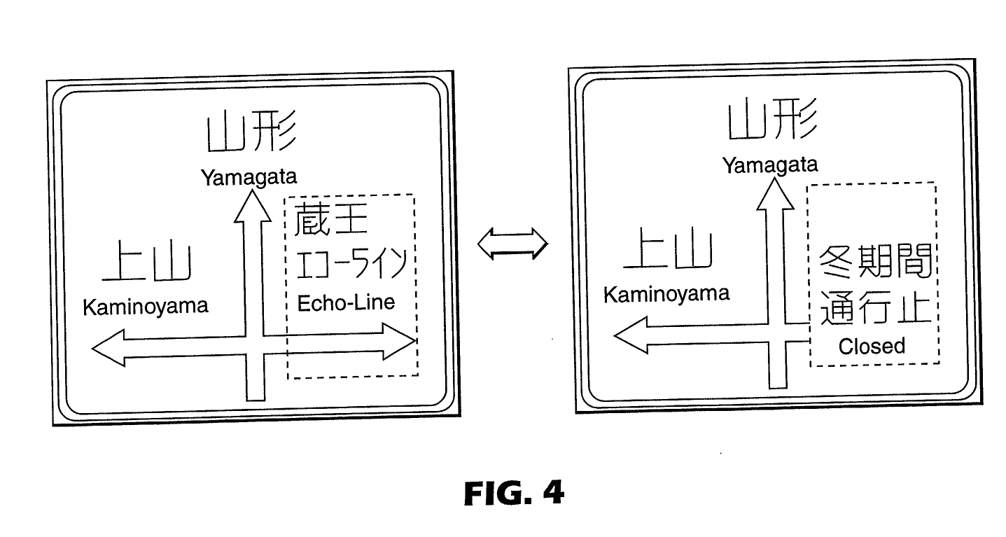

The variable image-displaying member of the present invention was produced as a rectangular module corresponding to an area surrounded by the dotted line of FIG. 4. The non-variable part of the sign of FIG. 4 was produced like in the case of a conventional printed static image sign. That is, the main part of the destination sign was produced by adhering the static image which had been prepared by screen printing the characters and arrows as shown in FIG. 4 on the reflective surface of the above reflective sheet sold under the trademark DIAMOND GRADE 3990 (white) using the above transparent blue ink, on the aluminum sign substrate.

In the above module, the visible pixel composed of the pixel element was in the form of a substantial square having a plane size of about 10 mm×about 10 mm (each shutter member being in the form of a substantial rectangle having a plane size of 5 mm×10 mm), since the displayed image included the Chinese characters.

An opening for attaching the above module was formed at the specific area of the main part of the destination sign, and then the module was attached to finish the variable image sign of this Example.

Like the sign of Example 1, the sign image on the left side of FIG. 4 and that on the right side of FIG. 4 were reversibly changed by the control of the operation of the electromagnets.

The dents of the visible pixels in the images displayed on the sign of this Example were much less harsh than those in Example 1, and the contours of the images were smooth, because the size of the visible pixel was smaller than that of Example 1.

When this image was observed from a distance of about 50 m to 100 m, the characters in the variable image were readable, and the shape and direction of the arrow could be recognized in the daytime and at night, like in the case of a conventional printed static image sign.

With the sign of this Example, the static states of the pixel elements can be controlled independently of each other. Thus, it can display other desired images freely in addition to the above two images, and therefore it is the free-pattern type variable sign.

### Example 3

This Example produced another variable directional sign displaying “partly variable directional sign of directions and courses”, which was different from that of Example 2. This destination sign can variably display two different sign images, when the traffic density varies between night and day. The variable sign of this Example was produced in the same manner as that in Example 2 except some points.

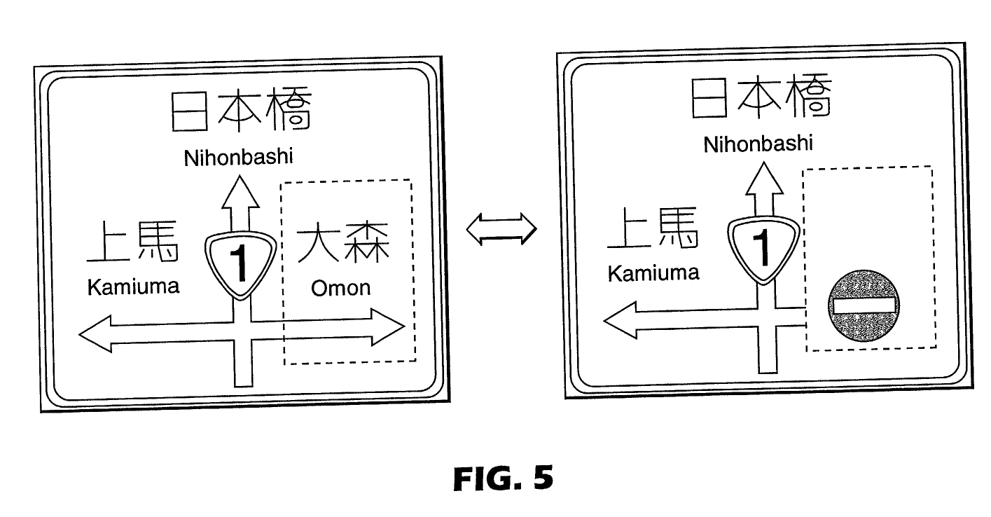

The rectangular module corresponding to an area surrounded by the dotted line of FIG. 5 (the variable image-displaying member) was produced like in the case of Example 2. The non-variable part of the sign of FIG. 5 was produced like in the case of a conventional printed static image sign. The module of this Example was used with synchronizing the static states of the pixel elements.

Firstly, to display the first image including “(in Japanese)/Omori” and the right arrow “→” in the first static state in which all the shutters were in the same direction, the second fixed faces of the fixed part and the second observable faces of the shutters were formed as follows:

On the above reflective sheet, i.e., No. 3990 (white), the above first image was printed with the transparent blue ink, and cut to a plurality of pieces—each having the specific area and shape. The cut pieces were suitably allocated to the second observable faces of the shutters and the second fixed faces so that a plurality of visible pixels, which were observed in the first static state, formed the above first image. The second observable face of each shutter was a substantial rectangle of 25 mm×50 mm.

Like in the above case of the second fixed faces of the fixed part and the second observable faces of the shutters, the first fixed faces of the fixed part and the first observable faces of the shutters were formed so that the second image including the circular sign of “NO ENTRY” was displayed. In this case, besides the blue transparent ink, a transparent red ink was also used to form the background of the circular sign.

Then, the assembled module was attached to the main art of the sign to finish the variable image sign of this Example.

When this image was observed from a distance of about 50 m to 100 m, the characters in the variable image were readable, and the shape and direction of the arrow could be recognized in the daytime and at night, like in the case of a conventional printed static image sign.

### Example 4

The variable image sign of this Example was produced in the same manner as in Example 2 except that a wide observation angle type reflective sheet sold under the trademark HV 8100 (available from Sumitomo 3M) was used as a reflective sheet.

When this sign was illuminated with a flood lamp sold under the designation “OPL-250” (available from Sumitomo 3M) at an illumination angle of about 20 degrees (with the normal direction to the reflective surface of the sign being 0 degree), the several variable images were brightly observed.

1. A variable image-displaying member comprising
(A) an opaque substrate having a front surface which is observed by an observer, and a back surface opposing said front surface, and
(B) a plurality of pixel elements which are arranged on said front surface of the substrate in the row directions and the column directions which are perpendicular to the row directions,
wherein each pixel element comprises
(a) a fixed part having the first fixed face which is fixed to said front surface of the substrate, the second fixed face adjacent to said first fixed surface, and a border line between said first fixed face and said second fixed face, and
(b) an opaque shutter which is rotatable around an axis, that is in parallel with said border line between said fixed faces, between the first static state to shield said first fixed face of said fixed part and the second static state to shield said second fixed face of said fixed part, and which has the second observable face observed by the observer in said first static state, and the first observable face observed by the observer in said second static state, and
in said first static state, said second fixed face of the fixed part and said second observable face of the shutter are juxtaposed each other to form the first visible pixel,
in said second static state, said first fixed surface of the fixed part and said first observable face of the shutter are juxtaposed each other to form the second visible pixel,
the static states of said pixel elements can be determined independently of each other or synchronously with each other,
thereby an image composed of a plurality of the visible pixels is displayed,
characterized in that
said first and second fixed faces consist of a respective reflective surface of a substantially opaque reflective member which covers said front surface of the substrate,
said first and second observable faces consist of a respective reflective surface of a substantially opaque reflective member which covers the surface and back surface of said shutter, and
said composed image is illuminated with an external light source and observed.

2. The variable image-displaying member according to claim 1, wherein said first fixed face and said first observable face are both colored white or in the first color, while said second fixed face and said second observable face are both colored with the second color.

3. The variable image-displaying member according to claim 1, wherein the static states of said pixel elements are determined independently of each other to display 3 or more different images.

4. The variable image-displaying member according to claim 1, wherein the static states of said pixel elements are determined synchronously with each other to display the first image composed of a plurality of the visible pixels observed in the first static state and the second image composed of a plurality of the visible pixels observed in the second static state.

5. The variable image-displaying member according to claim 1, wherein said first fixed face and said second fixed face are continuously arranged along said borderline between them.
